(19) United States
(12) Patent Application Publication
(10) Pub. No.: US 2023/0116510 A1
(43) Pub. Date: Apr. 13, 2023

(54) ANCHOR NETWORK ADDRESS TRANSLATION (NAT) FLOW ACCESS POINT (AP) SELECTION IN A MULTI-AP DEPLOYMENT

(71) Applicant: HEWLETT PACKED ENTERPRISE DEVELOPMENT LP, Houston, TX (US)

(72) Inventors: Nilay Shroff, Bangalore (IN); Piyush Agarwal, Santa Clara, CA (US); Narayanasami Vijayaraghavan, Bangalore (IN); Mohan Ram Bhadravati Ramakrishna Bhat, Bangalore (IN)

(21) Appl. No.: 17/498,728

(22) Filed: Oct. 11, 2021

(51) Int. Cl. H04W 40/32; H04L 29/12; H04W 36/32; H04W 36/18

(52) U.S. Cl. CPC H04W 40/32; H04L 61/2575; H04W 36/32; H04W 36/18

(57) ABSTRACT

Network address translation (NAT) flow migration between wireless access points (APs) in a manner that ensures that client devices can seamlessly roam between APs is described. An AP on which a NAT flow is first created is designated as an anchor NAT flow AP for that NAT flow during the lifetime of the NAT flow. When a non-anchor AP to which a client has roamed receives a packet that matches an active NAT flow, the non-anchor AP forwards the packet to the anchor AP for that NAT flow. The roamed AP may consult NAT flow uplink session information to identify the anchor AP as a next hop for the matching packet. Upon receipt, the anchor AP source NATs the packet with its own IP address and routes the packet towards the Internet. Downlink packets that match the NAT flow are routed in a similar manner through the anchor AP.

### BACKGROUND

Network address translation (NAT) involves the mapping of one Internet Protocol (IP) address space into another by modifying network address information in the IP header of a packet while it is in-transit across a traffic-routing device. Most network address translators map multiple private hosts to one publicly exposed IP address. In a typical configuration, a local network uses one of various available designated private IP address subnets. A router in that network has a private address of that address space. The router is also connected to the Internet with a public address, typically assigned by an Internet service provider. As network traffic passes from the local network to the Internet, the source address in each packet is translated on-the-fly from a private address to the router's public address. The router tracks basic data about each active connection. When a reply packet is received, the router uses the connection tracking data stored during the outbound phase to determine the private address on the internal network to which to forward the reply.

### BRIEF DESCRIPTION OF THE DRAWINGS

The present disclosure, in accordance with one or more various aspects, is described in detail with reference to the following figures. The figures are provided for purposes of illustration only and merely depict typical or example aspects.

FIG. 1A schematically depicts an updated active NAT flow through an anchor NAT flow AP selected in response to a client device roaming to a new AP according to example aspects of the disclosed technology.

FIG. 1B schematically depicts multiple simultaneous updated NAT flows through respective anchor NAT flow APs selected in response to a client device roaming to multiple different APs according to example aspects of the disclosed technology.

FIG. 1C schematically depicts a return to an original NAT flow when a client device roams to the AP with which it was originally associated according to example aspects of the disclosed technology.

FIG. 2 is a flowchart of an illustrative method for selecting an anchor NAT flow AP and updating a corresponding active NAT flow for a client device in response to the client device roaming to a new AP according to example aspects of the disclosed technology.

FIG. 3 is a flowchart of an illustrative method for updating NAT flow downlink session information in response to receiving a NAT flow migration message according to example aspects of the disclosed technology.

FIG. 4 is a flowchart of an illustrative method for routing packets based on an updated NAT flow through an anchor NAT flow AP according to example aspects of the disclosed technology.

FIG. 5 is an example computing component that may be used to implement various features of example aspects of the disclosed technology.

The figures are not exhaustive and do not limit the present disclosure to the precise form disclosed.

### DETAILED DESCRIPTION

The technology disclosed herein relates to methods/techniques for handling NAT flow migration in a manner that ensures that client devices can seamlessly roam between wireless access points (APs). Network devices and protocols configured to implement such methods and computer-readable media storing executable instructions for implementing such methods are also disclosed. As used herein, seamless roaming may refer to a client device roaming from one AP to another without resulting in termination or degradation of existing active network connections between the client device and other network resources such as resources on the Internet.

In a typical multi-AP microbranch deployment, APs may be configured to perform NAT processing on packets received from client devices and destined for an Internet resource such as a web server. More specifically, an AP may “source NAT” a packet from a client device by modifying a source address field of an IP header of the packet to replace an IP address of the client device with an IP address of the AP. In some cases, the IP address of the client device may be a private IP address that Internet resources cannot recognize. As such, the source natting performed by an AP may include translating a private IP address of a client device to a public IP address of the AP which, in contrast to the client's private IP, can be recognized and identified by Internet resources. After source natting a packet, an AP may forward the packet to the next hop, which may be an edge router, or potentially, a switch that sits in between the AP and the edge router.

In some cases, the edge router may perform an additional network address translation and source NAT the received packet by replacing the AP's IP address with an IP address of the edge router before routing the packet to its intended Internet destination, for example. In those scenarios in which an edge router performs an additional network address translation, the AP's IP address may not be a public IP address recognizable on the Internet, but may nonetheless be an “Internet-facing” IP address that is recognizable to the edge router. That is, the AP IP address may be a private IP address on the local network deployment, but may differ from the private IP address of a client device in that it may be an “Internet-facing” IP address that is recognizable to an edge router, which may sit outside of the local network deployment.

NAT processing performed by an AP may further include “destination natting” a packet that is received from a network resource (e.g., an Internet resource) and destined for a client device. The packet received from the network resource may include the IP address of the receiving AP in the destination address field of the IP header of the packet. An AP may “destination NAT” such a packet by modifying the destination address field to replace the AP's IP address with an IP address of the client device that is the ultimate intended destination for the packet.

A client device seeking to access a network resource (e.g., an Internet resource) may establish a Transmission Control Protocol (TCP)/Internet Protocol (IP) connection with the network resource. An AP may then generate a corresponding NAT flow for the newly established active session between the client device and the network resource. The NAT flow may associate packets exchanged between the client device and the network resource during the active session, e.g., over the TCP/IP connection. NAT flow session information may be generated for the NAT flow. The NAT flow session information may include information that indicates how an uplink packet should be source natted prior to routing the packet to the Internet, for example, and how a downlink packet should be destination natted prior to routing the packet to a destination client device.

That is, the NAT flow session information may indicate which AP IP address should be included in the source address field of an IP header of a packet and which client device IP address should be included in the destination address field of the IP header. An AP may utilize this NAT flow session information to source NAT a packet received from a client device in the uplink direction and destination NAT a response packet received in the downlink direction.

It should be appreciated that a packet sent/routed in the “uplink direction” (also referred to herein as an “uplink packet”) is a packet sent from a downstream network device (e.g., an end-user client device) to an upstream network device (e.g., an AP, a switch, a router, etc.). An uplink packet may hop between multiple upstream network devices as it is routed to its ultimate network destination (e.g., an Internet resource). For instance, a client device may send an uplink packet to an AP with which it is associated. The AP may then send the received packet to a network router (potentially via a switch), and the network router may route the packet to the Internet, for example. Conversely, a packet sent/routed in the “downlink direction” (also referred to herein as a “downlink packet”) is a packet sent from an upstream network device (e.g., a router, a switch, an AP, etc.) to a downstream network device (e.g., a client device). A downlink packet may similarly may hop between multiple downstream network devices before reaching its intended destination (e.g., an end-user client device). For instance, a network router may receive a downlink packet from the Internet and route the packet to an AP (potentially via a switch). The AP may then route the packet to its intended destination such as a client device.

Network address translation can present various technical problems in certain scenarios. As noted, an AP that receives uplink packets from a client device that are destined for the Internet, source NATs the packets with its IP address and forwards the source natted packets towards the Internet. Packets exchanged over an active TCP/IP connection between the client device and an Internet resource may be associated with one another through a corresponding NAT flow. In particular, after a client device has associated with a given AP, the client may establish a TCP/IP connection with a desired network resource (e.g., an Internet server) and send an uplink packet destined for that network resource destination. The AP may then and create a corresponding NAT flow that associates packets exchanged across the established network connection. The client device may subsequently roam to another AP for any of a variety of reasons. For instance, the client device may be a mobile client such as a smartphone. As a user of the smartphone moves through a physical space that includes the AP deployment, the mobile device may detect a stronger signal strength from an AP other than the one with which it is currently associated, in which case, it may associate with this new AP. As another non-limiting example, the current AP may hand-off the client device to a neighbor AP if the load on the current AP exceeds a threshold. It should be appreciated that a client device may roam between APs in a deployment for other reasons as well.

Assuming that a client device has roamed to a new AP, active NAT flows associated with the client device may be migrated from the prior AP to the new AP. This results in a technical problem because a subsequent packet sent from the client device that is associated with a migrated active NAT flow would egress from this new AP to which the client has roamed rather than from the prior AP that generated the NAT flow. More specifically, the packet received at the new AP from the roamed client device would be source natted with the new AP's IP address rather than the IP address of the prior AP. When the packet is ultimately received at the edge router, the edge router may perform a NAT flow lookup to determine the NAT flow that matches the received packet. A NAT flow may be identifiable by a set of NAT flow parameters. The set of NAT flow parameters may be represented as a 5-tuple that includes a source IP address, a source port number, a destination IP address, a destination port number, and a protocol type. A packet may be determined to match a particular NAT flow if information contained in an IP header of the packet and/or information contained in a TCP header of the packet, for example, matches the 5-tuple identifier of the particular NAT flow.

Referring again to the example above, when the edge router performs the NAT flow lookup for the packet received from the new AP to which the client device has now roamed—which is source natted with the IP address of the new AP—the lookup may fail to retrieve a matching NAT flow. In particular, because the source IP address in the IP header of the packet is the IP address of the new AP rather than the IP address of the prior AP which created the NAT flow, the packet header information will not match the 5-tuple identifier of the NAT flow. In particular, while the other NAT flow parameters may match, the source IP address in the packet header will not match the source IP address in the 5-tuple of any active NAT flow. This may cause the NAT flow to break, and in turn, could result in the corresponding TCP/IP connection being terminated. For example, if a user initiates a Voice over Internet Protocol (VoIP) call while connected to a first AP but then roams to a second AP while the VoIP call is still active, the call could drop as a result of packets being sourced natted with an IP address of the second AP rather than a IP address of the first AP. In particular, the NAT flow associated with the call expects the first AP's IP address in the source address field, and its absence may cause the NAT flow to break and the call to terminate.

An existing technique for addressing the above-mentioned technical problem associated with migrating NAT flows between APs when a client roams from one AP to another involves the use of a conductor AP to create NAT flows. Under this technique, when a client sends a packet that is destined for the Internet, a corresponding NAT flow is created on the conductor AP. If the client is associated with a member AP or if the client roams from the conductor AP to a member AP, then the member AP forwards any packet that matches the NAT flow to the conductor AP, which then source NATs the packet with its IP address prior to routing the packet to the Internet. While this existing approach may address the problem of NAT flow migration leading to connection termination/degradation, it nonetheless suffers from a number of technical drawbacks.

One drawback of this approach is that it is not scalable. For instance, if there are thousands of client devices connected to APs in a swarm, and hundreds or thousands of NAT flows are established for each client, the likelihood that the conductor AP becomes overloaded increases dramatically. Another drawback of this conductor AP-based approach is that all NAT flows are created exclusively by the conductor AP, and if the conductor AP fails—which as noted earlier becomes increasingly likely as the network scales—then all active NAT flows will break, resulting in the termination/degradation of corresponding TCP/IP connections.

The disclosed technology provides a technical solution to the above-described technical problem of NAT flow breakage during client roaming—a solution that eliminates the drawbacks associated with the existing AP conductor-based NAT flow creation technique described above. In particular, according to various aspects of the disclosed technology, an AP on which a NAT flow is first created is designated as an anchor NAT flow AP for that NAT flow during the lifetime of the NAT flow (i.e., as long as the corresponding TCP/IP connection is active). More specifically, for any AP in the deployment that creates a NAT session for a client, and where the client then roams to another AP while the NAT flow is still active, the AP that created the NAT flow serves as an anchor NAT flow AP for that NAT flow. Then, according to aspects of the disclosed technology, when the non-anchor AP to which the client has roamed receives a packet that matches the NAT flow, it forwards the packet to the anchor NAT flow AP for that NAT flow.

In particular, the roamed AP may consult NAT flow uplink session information to identify the anchor NAT flow AP as a next hop for the matching packet. Upon receipt, the anchor NAT flow AP source NATs the packet with its own IP address and routes the packet towards the Internet. Downlink packets that match the NAT flow are routed in a similar manner through the anchor NAT flow AP. In particular, when the anchor NAT flow AP receives a downlink packet that matches the NAT flow, it may destination NAT the packet with the client device's IP address (i.e., replace its IP address with the IP address of the client in the destination address field of the IP header of the packet), and then route the packet to the roamed AP based on NAT flow downlink session information associated with the NAT flow. More specifically, the NAT flow downlink session information may indicate to the anchor NAT flow AP that the roamed AP is a next hop for downlink packets that match the NAT flow. It should be appreciated that a multi-AP deployment may include multiple anchor NAT flow APs associated with a given client device if, for example, the client roams between multiple APs and at least one NAT flow is created for the client on each AP.

Aspects of the disclosed technology solve the technical problem of NAT flow breakage during client roaming. In particular, because the AP at which a NAT flow is first created serves as an anchor NAT flow AP for that NAT flow throughout its lifetime, the possibility of NAT flow breakage due to client roaming is eliminated. More specifically, according to example aspects of the disclosed technology, assuming that a client has roamed from a first AP at which an active NAT flow was created to a second AP, an uplink packet received at the second AP that matches the active NAT flow is routed to the first AP because the first AP serves as the anchor NAT flow AP for that NAT flow. This may be referred to herein as an updated NAT flow, whereby packets matching the NAT flow are routed through the first AP serving as an anchor NAT flow AP for the NAT flow.

Upon receipt of the packet from the second AP, the first AP source NATs the packet with its IP address prior to routing the packet towards the Internet. In this manner, packets that match an active NAT flow are always source natted with the expected IP address of the AP that created the NAT flow (i.e., the anchor NAT flow AP) regardless of which AP initially receives the packets from a client. As such, the stability of a NAT flow is ensured despite the client potentially roaming to a different AP than the AP at which the NAT flow was initially created. Moreover, packets matching a NAT flow are routed to the anchor NAT flow AP for that NAT flow and source natted with the IP address of the anchor NAT flow AP regardless of how many other APs the client may roam to. For instance, in the example introduced above, if the client roams from the second AP to a third AP, packets that match the NAT flow created at the first AP would now be routed from the third AP to the first AP, which continues to serve as the anchor NAT flow AP for that NAT flow.

In addition to solving the technical problem of NAT flow breakage during client roaming, aspects of the disclosed technology also eliminate the technical problems introduced by the above-described existing technique employed to handle NAT flow migration during client roaming—the AP conductor-based approach. As noted, according to aspects of the disclosed technology, any AP in a deployment that creates a NAT flow thereafter serves as the anchor NAT flow AP for that NAT flow. As such, according to aspects of the disclosed technology, NAT flows are distributed across the APs in a deployment rather than being centrally created at and routed through a single conductor AP. Because any given AP can create a NAT flow and then serve as the anchor NAT flow AP for that NAT flow such that the responsibility for source natting packets matching that NAT flow falls on the anchor AP regardless of which AP may have received the packets from a client device, the load associated with creating NAT flows, source natting packets matching the NAT flows, and routing the source natted packets does not fall exclusively on a single conductor AP, but rather, is distributed among the various APs serving as anchor NAT flow APs.

In this manner, as the network scales and the number of client devices and corresponding NAT flows that are created increases into the thousands, for example, the likelihood that a single AP is overloaded while serving as an anchor NAT flow AP is dramatically reduced because the NAT flows and the associated anchor NAT flow AP responsibilities would necessarily be distributed across the APs in the deployment rather than being centralized at a single AP. Moreover, according to aspects of the disclosed technology, if any given anchor NAT flow AP fails, only those NAT flows that are anchored to that AP would break, while the remaining NAT flows would remain stable because they are anchored to APs that are still operational. This stands in sharp contrast to the single conductor AP approach, where failure of the conductor AP tasked with creating all NAT flows and source natting all packets causes all NAT flows in the swarm to break.

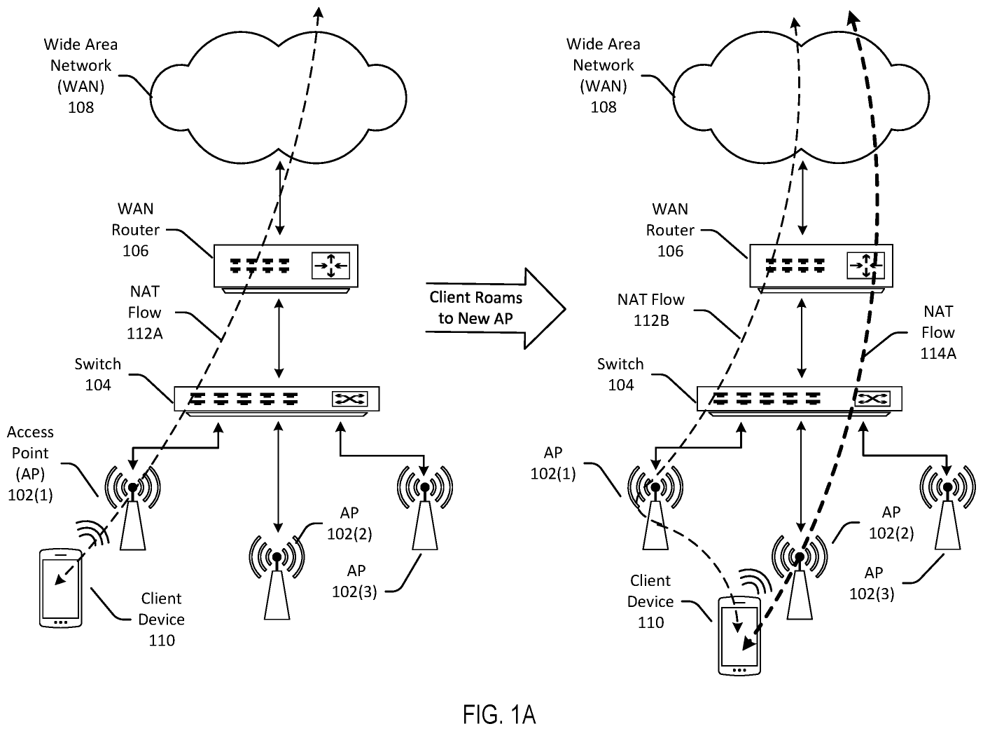

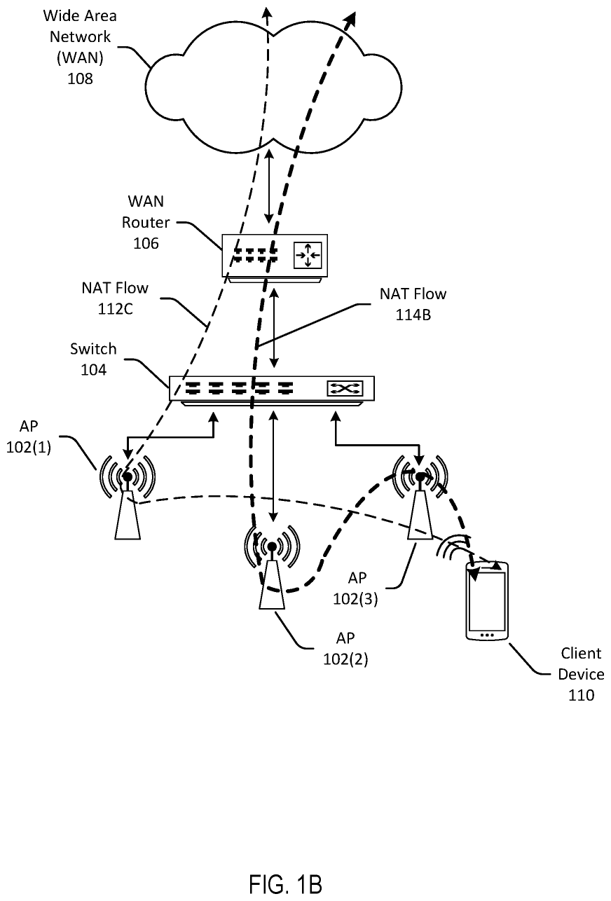

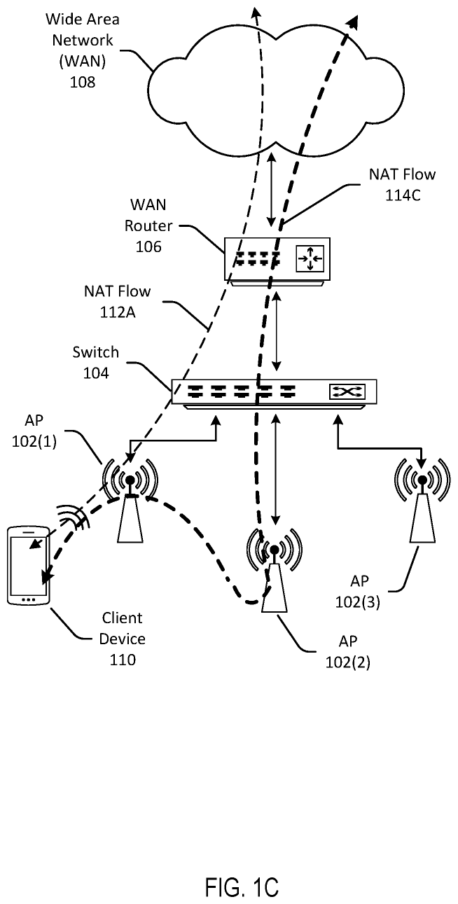

FIG. 1A schematically depicts the identification of an anchor NAT flow AP in response to a client device roaming to a new AP and the updating of a corresponding NAT flow to route packets matching the NAT flow through the anchor NAT flow AP. FIG. 1A depicts an example AP deployment that includes three APs— a first AP 102(1), a second AP 102(2), and a third AP 102(3). In some aspects, the APs 102 may form part of a split-tunnel microbranch deployment, according to which packets can be routed internally via a virtual private connection (VPN) tunnel, for instance, or to an external resource such as one on the Internet. A microbranch AP deployment may contain a cluster (“swarm”) of APs up to some threshold number of APs (e.g., 32 or 64 APs) that can in turn serve up to some threshold number of client devices (e.g., 500 clients). It should be appreciated that this is merely an example type of deployment and that aspects of the disclosed technology can be implemented in a variety of types of multi-AP deployments. It should be further appreciated that the number of APs in an actual deployment may be substantially greater that what is depicted.

In some aspects, the APs 102(1)-102(3) (generically referred to herein as AP 102) in the deployment may be wireless access points that provide network connectivity to client devices. While a single client device 110 is depicted for simplicity, it should be appreciated that multiple client devices may be simultaneously associated with each AP 102. Client device 110 is illustratively depicted on the left side of FIG. 1A as being associated with AP 102(1). In some aspects, the APs 102(1)-102(3) may form part of an AP swarm within a private network. As such, when the client device 110 is associated with a given AP 102 (e.g., AP 102(1)), that AP 102 may provide the client device 110 with connectivity to a public wide area network (WAN) 108 such as the Internet.

For example, assuming APs 102 are wireless APs, when the client device 110 associates with AP 102(1), it exchanges data with AP 102(1) wirelessly via RF signals. The client device 110 may send packets to AP 102(1) in the uplink direction and receive packets from AP 102(1) in the downlink direction. In particular, AP 102(1) may forward packets received from the client device 110 in the uplink direction to a WAN router 106. The WAN router 106 may be an edge router that connects a private network formed from the APs 102 with the broader WAN 108, which may be the Internet. In some aspects, the APs 102 are connected to a network switch 104 (e.g., an L2 switch), which in turn, is connected to the WAN router 106. The APs 102 may be connected to the switch 104 via wired Ethernet connections, for example. In addition to routing uplink packets received from the client device 110 towards the WAN 108, AP 102(1) may also route downlink packets that it receives from the WAN 108 (via the WAN router 106) to the client device 110.

As previously described, after the client device 110 associates with AP 102(1), the client device 110 may establish a new TCP/IP connection with a particular resource in the WAN 108 (e.g., a web server). The client device 110 may then send a packet to AP 102(1) that is destined for this WAN resource. AP 102(1) may, in turn, create a new NAT flow 112A corresponding to the new active session. As part of creating NAT flow 112A, AP 102(1) may generate and store NAT flow session information including NAT flow uplink session information and NAT flow downlink session information. The NAT flow uplink session information may indicate a next hop for any uplink packet that matches NAT flow 112A. The next hop from AP 102(1) for a packet received from the client device 110 that matches NAT flow 112A may be the WAN router 106, for example. The NAT flow uplink session information may further indicate that uplink packets received from client device 110 that match NAT flow 112A are to be source natted with an IP address of AP 102(1). Similarly, the NAT flow downlink session information may indicate a next hop for any downlink packet that matches NAT flow 112A. The next hop from AP 102(1) for a packet received from, for example, WAN router 106 in the downlink direction may be the client device 110. The NAT flow downlink session information may further indicate that downlink packets that match NAT flow 112A are to be destination natted with an IP address of the client device 110.

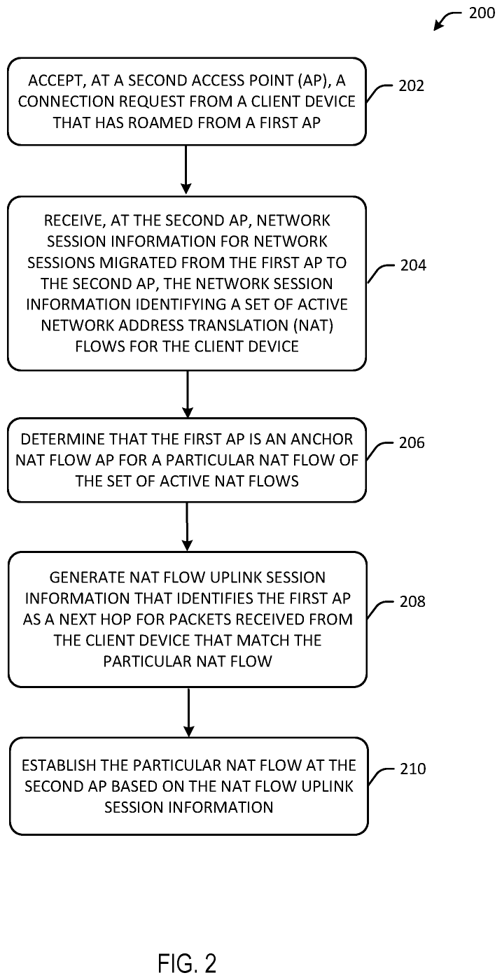

In example scenarios, the client device 110 may roam from AP 102(1) to another AP in the swarm such as AP 102(2), as shown on the right side of FIG. 1A. As described hereinafter in reference to the illustrative method 200 of FIG. 2, after client device 110 roams from AP 102(1) to AP 102(2), active NAT flows at AP 102(1) may be migrated from AP 102(1) to AP 102(2), and a process may be initiated to identify AP 102(1) as an anchor NAT flow AP for NAT flows that it created for client device 110 and to establish updated NAT flows that route through AP 102(1) for those NAT flows for which AP 102(1) is identified as the anchor NAT flow AP. FIG. 2 recites a first AP and a second AP which correspond to AP 102(1) and AP 102(2), respectively, in the example implementation of FIGS. 1A-1C.

Referring now to FIG. 2 in the context of the example network depicted in FIG. 1A, at block 202, AP 102(2) may receive and accept a request to associate from the client device 110. As noted, the client device 110 was previously associated with AP 102(1), but has now roamed to AP 102(2). The client device 110 may have roamed to AP 102(2) if, for example, the signal strength observed at the client device 110 for AP 102(2) becomes stronger and the observed signal strength for AP 102(1) becomes weaker as the client device 110 physically moves through the deployment space.

At block 204, AP 102(2) may receive migrated active sessions from AP 102(1). More specifically, AP 102(2) may receive network session information from AP 102(1) indicative of active NAT flow sessions between the client device 110 and various network resources. For instance, the network session information may include a 5-tuple of NAT flow parameters for each active NAT flow. The network session information may further include NAT flow uplink and downlink session information that indicates a next hop for routing packets in the uplink direction and a next hop for routing packets in the downlink direction, respectively.

At block 206, AP 102(2) may determine, from the received network session information, that AP 102(1) is an anchor NAT flow AP that created a particular NAT flow (e.g., NAT flow 112A) of the set of active NAT flow sessions that were migrated from AP 102(1) to AP 102(2) when client device 110 roamed from AP 102(1) to AP 102(2). In particular, AP 102(2) may determine that AP 102(1) is the anchor NAT flow AP for NAT flow 112A if an IP address of AP 102(1) is the source address in a 5-tuple identifier of the NAT flow 112A. In other example aspects, an additional NAT flow parameter, flag, or the like may be provided to designate the anchor AP for each NAT flow. It should be appreciated that AP 102(1) may be an anchor NAT flow AP for one or more other NAT flows as well, and that disclosure herein of updating NAT flow 112A after client device 110 roams to AP 102(2) to have it route through anchor AP 102(1) is equally applicable to any additional NAT flow(s) for which AP 102(1) is an anchor AP.

At block 208 of the method 200, AP 102(2) generates NAT flow uplink session information that identifies AP 102(1) as a next hop for packets received from the client device 110 that match NAT flow 112A. Then, at block 210, AP 102(2) establishes NAT flow 112A locally as updated NAT flow 112B based on the NAT flow uplink session information that identifies AP 102(1) as a next hop for uplink packets received from client device 110 that match NAT flow 112A/112B. NAT flow 112B may share the same 5-tuple identifier as NAT flow 112A and may be viewed as the same NAT flow, but may differ with respect to their associated NAT flow uplink session information, which in the case of NAT flow 112B, may designate AP 102(1) as a next hop for matching uplink packets received at AP 102(2). This modified NAT flow uplink session information causes uplink packets to be routed through AP 102(1) rather than being routed directly to the WAN router 106, as was the case in the scenario depicted on the left side of FIG. 1A when the client device 110 was associated with AP 102(1) prior to roaming to AP 102(2). Installing NAT flow 112A at AP 102(2) as NAT flow 112B where all matching packets are routed through anchor NAT flow AP 102(1) ensures that AP 102(1) is able to source NAT all matching uplink packets with its IP address prior to routing them to the WAN router 106. This, in turn, ensures that the WAN router 106 matches the packets to the correct 5-tuple NAT flow identifier and that the stability of the NAT flow 112B and the corresponding TCP/IP connection is maintained.

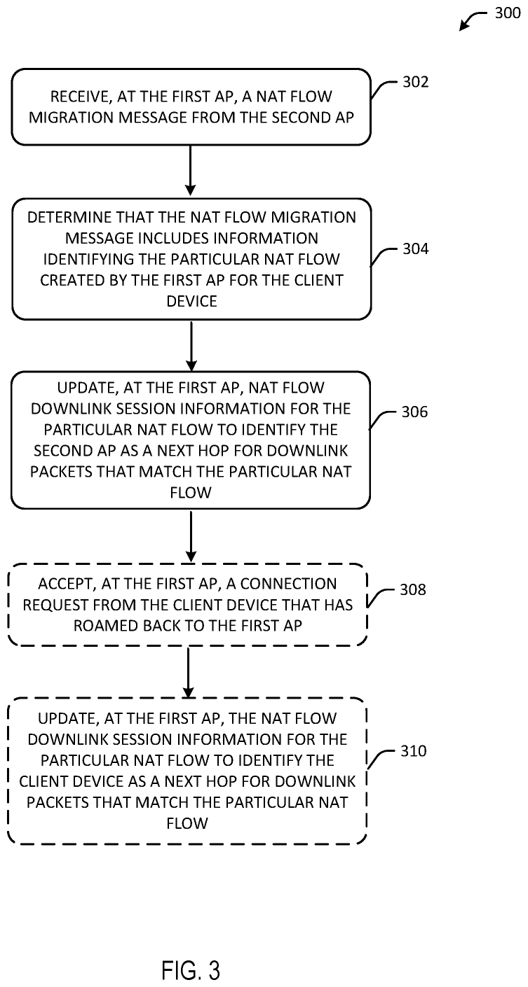

As noted, AP 102(2) knows to route, to AP 102(1), packets received from client device 110 that match NAT flow 112B based on the associated NAT flow uplink session information stored at AP 102(2) for NAT flow 112B. In particular, the uplink session information indicates that AP 102(1) is a next hop for uplink packets received at AP 102(2) that match NAT flow 112B. AP 102(1) similarly needs to know to route downlink packets that match NAT flow 1128 to AP 102(2) rather than directly to client device 110 because client 110 is now associated with AP 102(2). This information is conveyed to AP 102(1) by updating the NAT flow downlink session information stored at AP 102(1). FIG. 3 depicts a flowchart of an illustrative method for updating NAT flow downlink session information stored at the first AP, i.e., the AP that the client device was associated with prior to roaming. The first and second APs referenced in FIG. 3 are the same as those referenced in FIG. 2 and, as noted earlier, correspond to AP 102(1) and AP 102(2), respectively, in the example implementation of FIGS. 1A-1C.

Referring now to FIG. 3 in the context of the example network depicted in FIG. 1A, at block 302 of the method 300, AP 102(1) receives a NAT flow migration message sent by AP 102(2). In particular, AP 102(2) may identify each AP that is an anchor NAT flow AP for at least one active NAT flow identified in the network session information received from AP 102(1) as part of the session migration that occurs when client device 110 roams from AP 102(1) to AP 102(2). AP 102(2) may then unicast a NAT flow migration message to each identified anchor NAT flow AP. The NAT flow migration message received by a given AP may indicate each active NAT flow (by way of its corresponding 5-tuple, for example) for which the given AP is an anchor NAT flow AP that created the NAT flow. In this example, for ease of explanation, it is assumed that AP 102(1) is the only anchor NAT flow AP identified, and thus, the only AP to which the NAT flow migration message is sent. It is further assumed for ease of explanation that NAT flow 112A is the only NAT flow for which AP 102(1) is an anchor NAT flow AP. It should be appreciated, however, that any number of other APs may be identified as anchor NAT flow APs for any number of other active NAT flows. It should further be appreciated that AP 102(1) may be an anchor NAT flow AP for NAT flow(s) other than NAT flow 112A.

At block 304 of the method 300, AP 102(1) may determine that the NAT flow migration message received from AP 102(2) includes information identifying NAT flow 112A, e.g., the 5-tuple identifier of NAT flow 112A. AP 102(1) may recognize NAT flow 112A as one that it created by locating its own IP address in the source address field of the 5-tuple identifier, for example. In other example aspects of the disclosed technology, an additional NAT flow parameter, flag, or the like may designate AP 102(1) as the anchor NAT flow AP for NAT flow 112A.

Then, at block 306 of the method 300, AP 102(1) may update NAT flow downlink session information stored locally for the NAT flow 112A to change the next hop from an IP address of the client device 110 to an IP address of AP 102(2). Based on this modified NAT flow downlink session information, AP 102(1) may route downlink packets matching NAT flow 112A to AP 102(2) rather than to client device 110. It should be appreciated that AP 102(1) may still destination NAT matching downlink packets with an IP address of the client address 110 even though it now routes those packets to AP 102(2) rather than directly to the client device 110. The illustrative method 300 of FIG. 3 further includes optional operations at blocks 308 and 310, which will be described in more detail later in this disclosure in reference to FIG. 1C.

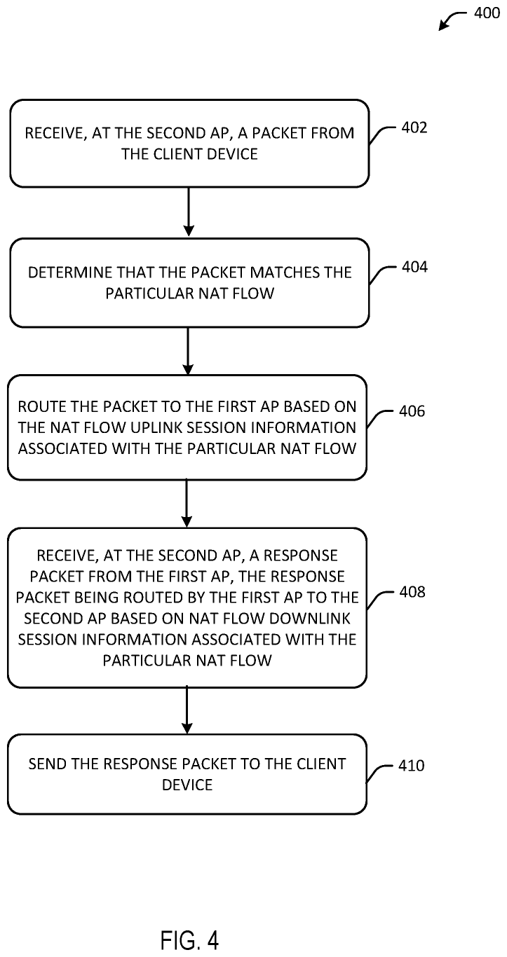

FIG. 4 is a flowchart of an illustrative method 400 for routing packets based on an updated NAT flow through an anchor NAT flow AP according to example aspects of the disclosed technology. The method 400 will be described hereinafter in the context of updated NAT flow 112B depicted in FIG. 1A. The first and second APs referenced in FIG. 4 are the same as those referenced in FIGS. 2 and 3 and, as noted earlier, correspond to AP 102(1) and AP 102(2), respectively, in the example implementation of FIGS. 1A-1C.

Referring now to FIG. 4 in conjunction with FIG. 1A, at block 402 of the method 400, AP 102(2) may receive an uplink packet from client device 110. At block 404, AP 102(2) may determine that the received packet matches NAT flow 112B. AP 102(2) may determine that the received packet matches NAT flow 112B by comparing information in an IP header and/or a TCP header of the received packet to the set of NAT flow parameters associated with NAT flow 1128. In particular, AP 102(2) may determine that the received packet matches NAT flow 1128 by determining that a source IP address, destination IP address, and network protocol type included in an IP header of the received packet and a source port number and destination port number included in a TCP header of the received packet match corresponding NAT flow parameters of NAT flow 1128. In some aspects, the IP header of the received packet may include the client device's 110 IP address because the packet has not yet been source natted. The client device's 110 IP address may not match the source IP address NAT flow parameter included in the 5-tuple identifier of NAT flow 1128, but the received packet may nonetheless be matched to NAT flow 1128 based on a match between one or more other NAT flow parameters and corresponding fields in the IP and TCP headers of the received packet. In alternative aspects of the disclosed technology, the 5-tuple identifier of NAT flow 1128 stored at AP 102(2) may include the client device's IP address as the source IP address, whereas the 5-tuple stored at WAN router 106, for example, may include the IP address of AP 102(1) as the source address. Further, as previously noted, NAT flow 112A and NAT 1128 may correspond to the same TCP/IP connection and may be identified by the same 5-tuple identifier.

At block 406 of the method 400, upon determining that the received packet matches NAT flow 1128, AP 102(2) may route the received packet to AP 102(1) based on NAT flow uplink session information associated with NAT flow 1128. More specifically, the NAT flow uplink session information may identify AP 102(1) as a next hop for the received packet that matches NAT flow 1128, and AP 102(2) may accordingly route the packet to AP 102(1). Upon receipt of the packet, AP 102(1) may recognize the packet as matching a NAT flow that it created, and may proceed to source NAT the packet by replacing the IP address of the client device 110 with the IP address of AP 102(1) in the source address field of the IP header of the packet. AP 102(1) may then forward the packet to WAN router 106. As previously noted, WAN router 106 may optionally perform another network address translation on the packet before sending the packet to its intended Internet destination.

Upon receipt of the packet, the destination resource may send a response packet. The response packet may be routed through AP 102(1). Upon receipt of the response packet, AP 102(1) may determine that it matches NAT flow 1128 and may route the response packet to AP 102(2) based on NAT flow downlink session information identifying AP 102(2) as a next hop for forwarding matching downlink packets. Prior to routing the response packet to AP 102(2), AP 102(1) may destination NAT the response packet with the IP address of the client device 110. AP 102(2) may receive the response packet at block 408, and proceed to forward the packet to client device 110, at block 410 of the method 400.

As shown in FIG. 1A, in some aspects, the client device 110—which has roamed to and is now associated with AP 102(2)— may send a packet to AP 102(2) that is intended for a network resource (e.g., an Internet destination) that is different than the intended destination of packets that match NAT flow 1128. In particular, client device 110 may establish a new TCP/IP connection with another resource in the WAN 108, and may send a packet to AP 102(2) that is intended for that network destination. In such a scenario, AP 102(2) may establish a new NAT flow 114A for the newly established active session involving the client device 110. Establishing NAT flow 114A at AP 102(2) may include generating associated NAT flow uplink session information that identifies WAN router 106, for example, as a next hop for uplink packets that match NAT flow 114A and generating associated NAT flow downlink session information that identifies client device 110 as a next hop for downlink packets that match NAT flow 114A. Moreover, because AP 102(2) created NAT flow 114A, AP 102(2) source NATs uplink packets matching NAT flow 114A with the IP address of AP 102(2) prior to routing the packets to WAN router 106 and destination NATs downlink packets matching NAT flow 114A with the IP address of the client device 110.

FIG. 1B depicts a scenario in which the client device 110 has now roamed from AP 102(2) to another AP, i.e., AP 102(3). Similar to when the client device 110 roamed from AP 102(1) to AP 102(2), all active sessions are migrated from AP 102(2) to AP 102(3). As part of migrating the active sessions, AP 102(2) may send session information to AP 102(3) that identifies all active NAT flows associated with client device 110. AP 102(3) may identify NAT flows 112B and 114A among the active NAT flows, and may further determine that AP 102(1) is the anchor NAT flow AP for NAT flow 112B and AP 102(2) is the anchor NAT flow AP for NAT flow 114A. AP 102(3) may then proceed to establish NAT flows 112B and 114A as NAT flows 112C and 114B, respectively, at AP 102(3). Establishing NAT flow 112C may include generating corresponding NAT flow uplink session information that identifies AP 102(1) as a next hop from AP 102(3) for uplink packets received from client device 110 that match NAT flow 112C. Similarly, establishing NAT flow 114B may include generating corresponding NAT flow uplink session information that identifies AP 102(2) as a next hop from AP 102(3) for uplink packets received from client device 110 that match NAT flow 114B.

AP 102(3) may then send a NAT flow migration message to each AP identified as an anchor NAT flow AP for at least one active NAT flow found in the migrated session information. In this example, AP 102(3) transmits a NAT flow migration message to AP 102(1) that includes the 5-tuple identifier of NAT flow 112A/112C and transmits a NAT flow migration message to AP 102(2) that includes the 5-tuple identifier of NAT flow 114A/114B. Upon receiving the NAT flow migration message, AP 102(1) may update the NAT flow downlink session information for NAT flow 112A/112C to set the next hop to AP 102(3). Similarly, upon receipt of its NAT flow migration message, AP 102(2) may update the NAT flow downlink session information for NAT flow 114A/114B to set the next hop to AP 102(3).

Based on NAT flow 112C and the associated NAT flow uplink session information stored at AP 102(3), an uplink packet received at AP 102(3) from client device 110 that matches NAT flow 112C hops to AP 102(1), which then source NATs the packet with the IP address of AP 102(1). The packet then hops to WAN router 106 and then to WAN 108 (e.g., the Internet). Conversely, a downlink packet that matches NAT flow 112C, hops from WAN router 106 to AP 102(1), which destination NATs the packet with an IP address of the client device 110. The downlink packet then hops to AP 102(3), which forwards the packet to client device 110.

In a similar manner, based on NAT flow 1148 and the associated NAT flow uplink session information stored at AP 102(3), an uplink packet received at AP 102(3) from client device 110 that matches NAT flow 1148 hops to AP 102(2), which then source NATs the packet with the IP address of AP 102(2). The packet then hops to WAN router 106 and then to WAN 108 (e.g., the Internet). Conversely, a downlink packet that matches NAT flow 1148, hops from WAN router 106 to AP 102(2), which destination NATs the packet with an IP address of the client device 110. The downlink packet then hops to AP 102(3), which forwards the packet to client device 110.

Assume now that client device 110 roams from AP 102(3) back to AP 102(1), as depicted in FIG. 1C. Referring again to FIG. 3 in conjunction with FIG. 1C, at block 308 of method 300, AP 102(1) may accept an association request from client device 110. AP 102(3) may migrate active sessions to AP 102(1), and AP 102(1) may identify itself as the anchor NAT flow AP for active NAT flow 112C (which is represented again as NAT flow 112A). AP 102(1) may then update, at block 310 of the method 300, the NAT flow downlink session information associated with NAT flow 112A to have the next hop point to the client device 110 which is now directly associated with AP 102(1), rather than AP 102(3) as was previously the case when the client device 110 was associated with AP 102(3). AP 102(1) would, however, identify AP 102(2) as the anchor NAT flow AP for NAT flow 1148, and proceed to establish NAT flow 1148 as NAT flow 114C and generate corresponding NAT flow uplink session information that identifies AP 102(2) as a next hop for uplink packets received from client device 110 that match NAT flow 114B/114C.

AP 102(1) may then unicast a NAT flow migration message to each AP identified as an anchor NAT flow AP for at least one active NAT flow found in the migrated session information. In this example, assuming that no NAT flows were created at AP 102(3), AP 102(1) only sends a NAT flow migration message to AP 102(2) that includes the 5-tuple identifier of NAT flow 114B/114C. Upon receiving the NAT flow migration message, AP 102(2) may update the NAT flow downlink session information for NAT flow 114B/114C to set the next hop to AP 102(1).

Based on NAT flow 112A and the associated NAT flow uplink session information stored at AP 102(1), AP 102(1) source NATs a packet received from client device 110 that matches NAT flow 112A with the IP address of AP 102(1), and then routes the packet to WAN router 106 and WAN 108. Conversely, a downlink packet that matches NAT flow 112A, hops from WAN router 106 to AP 102(1), which destination NATs the packet with an IP address of the client device 110. The downlink packet then hops to client device 110. Thus, packet routing for packets that match NAT flow 114A is the same in the scenario of FIG. 1C as it is in the scenario of FIG. 1A.

In contrast, based on NAT flow 114C and the associated NAT flow uplink session information stored at AP 102(1), an uplink packet received at AP 102(1) from client device 110 that matches NAT flow 114C hops to AP 102(2), which then source NATs the packet with the IP address of AP 102(2). The packet then hops to WAN router 106 and then to WAN 108 (e.g., the Internet). Conversely, a downlink packet that matches NAT flow 114C, hops from WAN router 106 to AP 102(2), which destination NATs the packet with an IP address of the client device 110. The downlink packet then hops to AP 102(1), which forwards the packet to client device 110.

It should be appreciated that the methods 200, 300, and/or 400 may be performed responsive to execution, by one or more processors, of corresponding sets of machine-executable instructions stored in machine-readable storage media. The machine-executable instructions may be stored on machine-readable storage media of the APs within a multi-AP deployment, for example. In some aspects, the stored instructions may be modularized into one or more computing engines/program modules. Each such computing engine may include a collection of machine-readable/machine-executable instructions, that when executed by a hardware processor, causes the hardware processor to perform corresponding tasks/processing. In some aspects, the set of tasks performed responsive to execution of the set of instructions forming a particular computing engine may be a set of specialized/customized tasks for effectuating a particular type/scope of processing. The aforementioned engines/program modules can be implemented in any combination of hardware, software, and/or firmware. In some aspects, these engines may be customized computer-executable logic implemented within a customized computing machine such as a customized field programmable gate array (FPGA) or an application specific integrated circuit (ASIC).

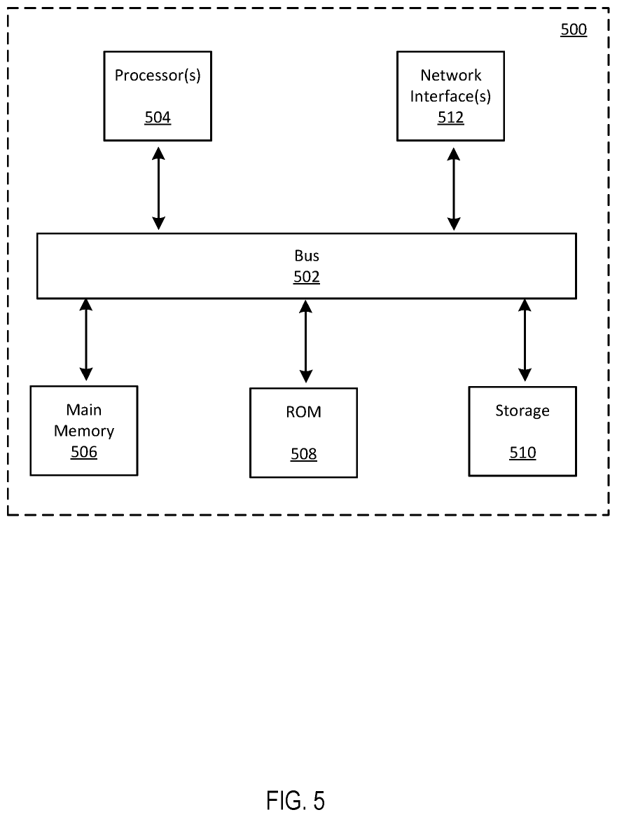

FIG. 5 depicts a block diagram of an example computer system 500 in which various of the aspects described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one aspect, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. For instance, instructions for implementing one or more of the methods 200, 300, or 400 may be loaded from the storage device 510 and/or the ROM 508 into the main memory 506 for execution by the processor(s) 504 to perform the operations of said methods. In alternative aspects, hard-wired circuitry may be used in place of or in combination with software instructions.

The term “non-transitory media,” and similar terms such as machine-readable storage media, as used herein, refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a network interface 512 coupled to bus 502. Network interface 512 provides a two-way data communication coupling to one or more network links that are connected to one or more local networks. For example, network interface 512 may be an integrated services digital network (ISDN) card, cable modem, satellite modem, or a modem to provide a data communication connection to a corresponding type of telephone line. As another example, network interface 512 may be a local area network (LAN) card to provide a data communication connection to a compatible LAN (or WAN component to communicated with a WAN). Wireless links may also be implemented. In any such implementation, network interface 512 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 512, which carry the digital data to and from computer system 500, are example forms of transmission media.

The computer system 500 can send messages and receive data, including program code, through the network(s), network link and network interface 512. In the Internet example, a server might transmit a requested code for an application program through the Internet, the ISP, the local network and the network interface 512. The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example aspects. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain aspects include, while other aspects do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent. Further, any description of a first thing/condition being “based” on a second thing/condition shall be construed as the first thing/condition being “based at least in part” on the second thing/condition.

What is claimed is:

1. A method, comprising:
receiving, at a second access point (AP) with which a client device is currently associated, from a first AP with which the client device was previously associated, session information relating to one or more active network address translation (NAT) flows for the client device;
determining, at the second AP, that the first AP is an anchor NAT flow AP that created a particular NAT flow of the one or more active NAT flows; and
establishing, at the second AP, the particular NAT flow, wherein establishing the particular NAT flow at the second AP comprises generating and storing NAT flow uplink session information at the second AP that identifies the first AP as a next hop to route packets matching the particular NAT flow that are received at the second AP from the client device in the uplink direction.

2. The method of claim 1, further comprising:
sending, by the second AP, a NAT flow migration message to each anchor AP identified for at least one NAT flow,
wherein, upon receipt of the NAT flow migration message, the first AP is configured to modify NAT flow downlink session information stored at the first AP for the particular NAT flow to designate the second AP as a next hop to route packets matching the particular NAT flow that are received at the first AP in a downlink direction.

3. The method of claim 1, wherein the particular NAT flow associates packets that are exchanged during a particular active Transmission Control Protocol (TCP)/Internet Protocol (IP) connection between the client device and a particular Internet destination.

4. The method of claim 1, further comprising:
receiving, at the second AP, from the client device, a first packet;
determining that the first packet matches the particular NAT flow;
determining, based on the NAT flow uplink session information, that the next hop for the first packet is the first AP; and
routing the first packet to the first AP.

5. The method of claim 4, wherein the first AP modifies a source address field in an Internet Protocol (IP) header of the first packet from a private IP address of the client device to a public IP address of the first AP prior to routing the first packet in an uplink direction towards the Internet.

6. The method of claim 4, wherein determining that the first packet matches the particular NAT flow comprises determining that Internet Protocol (IP) header information of the first packet and Transmission Control Protocol (TCP) header information of the first packet matches a set of NAT flow parameters associated with the particular NAT flow, the set of NAT flow parameters including a source IP address, a destination IP address, a source port number, a destination port number, and a network protocol type.

7. The method of claim 4, further comprising:
receiving, at the second AP, from the first AP, a second packet in response to the first packet;
determining that the second packet matches the particular NAT flow; and
routing the second packet to the client device.

8. The method of claim 7, wherein the first AP modifies a destination address field in an Internet Protocol (IP) header of the second packet from a public IP address of the first AP to a private IP address of the client device prior to routing the second packet to the second AP.

9. The method of claim 4, wherein the particular NAT flow is a first NAT flow, the method further comprising:
receiving, at the second AP, from the client device, a second packet;
determining that the second packet does not match any active NAT flow;
establishing a network connection between the client device and a particular Internet destination of the second packet; and
creating a second NAT flow that associates packets exchanged across the network connection established between the client device and the particular Internet destination of the second packet.

10. The method of claim 9, further comprising:
receiving, at the second AP, from the client device, a second packet;
determining that the second packet matches the second NAT flow;
modifying a source address field in an Internet Protocol (IP) header of the second packet from a private IP address of the client device to a public IP address of the second AP; and
routing the second packet with the modified source address field in an uplink direction towards the Internet.

11. A wireless access point, comprising:
a memory storing machine-executable instructions; and
a processor configured to access the memory and execute the machine-executable instructions to:
accept an association request from a client device, wherein the client device has roamed from a first AP;
receive, from the first AP, session information relating to one or more active network address translation (NAT) flows for the client device;
determine that the first AP is an anchor NAT flow AP that created a particular NAT flow of the one or more active NAT flows; and
establish the particular NAT flow locally, wherein establishing the particular NAT flow locally comprises generating local NAT flow uplink session information that identifies the first AP as a next hop to which to route uplink packets matching the particular NAT flow that are received at the wireless access point from the client device.

12. The system of claim 11, wherein the processor is further configured to execute the machine-executable instructions to:
send a NAT flow migration message to each anchor AP identified for at least one NAT flow,
wherein, upon receipt of the NAT flow migration message, the first AP is configured to modify NAT flow downlink session information stored at the first AP for the particular NAT flow to designate the second AP as a next hop for downlink packets matching the particular NAT flow that are received at the first AP.

13. The system of claim 11, wherein the processor is further configured to execute the machine-executable instructions to:
receive, from the client device, a first packet;
determine that the first packet matches the particular NAT flow;
determine, based on the NAT flow uplink session information, that the next hop for the first packet is the first AP;
route the first packet to the first AP;
receive, from the first AP, a second packet in response to the first packet;
determine that the second packet matches the particular NAT flow; and
route the second packet to the client device.

14. The system of claim 13, wherein the first AP modifies a source address field in an Internet Protocol (IP) header of the first packet from a private IP address of the client device to a public IP address of the first AP prior to routing the first packet in an uplink direction towards the Internet, and
wherein the first AP modifies a destination address field in an IP header of the second packet from the public IP address of the first AP to a private IP address of the client device prior to receiving the second packet from the first AP.

15. The system of claim 13, wherein the particular NAT flow is a first NAT flow, and wherein the processor is further configured to execute the machine-executable instructions to:
receive, from the client device, a third packet;
determine that the third packet does not match any active NAT flow;
establish a network connection between the client device and a particular destination of the third packet; and
create a second NAT flow that associates packets exchanged across the network connection established between the client device and the particular Internet destination of the third packet.

16. A method, comprising:
responsive to a client device roaming from a first access point (AP) to a second AP, migrating one or more active sessions for the client device from the first AP to the second AP, the one or more migrated active sessions including a first one or more active network address translation (NAT) flows associated with the client device;
receiving, at the first AP, a NAT flow migration message from the second AP;
determining, based on the NAT flow migration message, that the first AP is an anchor NAT flow AP for a particular NAT flow of the first one or more active NAT flows; and
modifying NAT flow downlink session information stored at the first AP for the particular NAT flow to designate the second AP as a next hop for packets matching the particular NAT flow that are received at the first AP in a downlink direction.

17. The method of claim 16, further comprising:
receiving, at the first AP, a first packet routed from the second AP on behalf of the client device;
determining that the first packet matches the particular NAT flow;
modifying a source address field in an Internet Protocol (IP) header of the first packet from a private IP address of the client device to a public IP address of the first AP; and
routing the first packet in an uplink direction towards the Internet.

18. The method of claim 17, further comprising:
receiving, at the first AP, a second packet in the downlink direction;
determining that the second packet matches the particular NAT flow;
determining, based on the NAT flow downlink session information, that the next hop for the second packet is the second AP; and
routing the second packet to the second AP in the downlink direction.

19. The method of claim 18, further comprising:
modifying a destination address field in an IP header of the second packet from the public IP address of the first AP to the private IP address of the client device prior to routing the second packet to the second AP.

20. The method of claim 16, further comprising:
accepting an association request from the client device, wherein the client device has roamed back to the first AP from the second AP;
receiving, from the second AP, session information indicative of a second one or more active NAT flows associated with the client device;
determining that the second one or more NAT flows includes the particular NAT flow; and
modifying the NAT flow downlink session information stored at the first AP for the particular NAT flow to designate the client device as the next hop for packets matching the particular NAT flow that are received at the first AP in the downlink direction.
